(19) United States
(12) Patent Application Publication
(10) Pub. No.: US 2007/0202215 A1
(43) Pub. Date: Aug. 30, 2007

(54) DIETARY NUTRITIONAL SUPPLEMENTS FOR PERSONS CONSUMING ALCOHOL PRODUCTS

(76) Inventor: Zahramehran Salari Lak, Gibsonia, PA (US)

Correspondence Address: BLYNN L. SHIDELER;THE BLK LAW GROUP, 3500 BROKKTREE ROAD, SUITE 200, WEXFORD, PA, 15090, US

(21) Appl. No.: 11/679,933

(22) Filed: Feb. 28, 2007

Related U.S. Application Data
(60) Provisional application No. 60/777,615, filed on Feb. 28, 2006.

(51) Int. Cl. A23L 1/302

(52) U.S. Cl. 426/61; 426/74

(57) ABSTRACT

A dietary nutritional supplement is designed specifically to address the needs of moderate to heavy alcohol product consumers. The nutritional supplement contains effective amounts of essential components vitamin B₂, vitamin B₆, vitamin B₁₂ (Cobalamin), vitamin B₃ (Niacin), vitamin B₁ (Thiamin), Calcium, magnesium, vitamin A, vitamin C (ascorbic acid), folic acid, L-cysteine, L-methionine, Milk Thistle, selenium, dandelion, and Molybdenum.

### CROSS REFERENCE TO RELATED APPLICATION

The present application claims the benefit of U.S. provisional patent application Ser. No. 60/777,615, entitled “DIETARY NUTRITIONAL SUPPLEMENTS FOR PERSONS CONSUMING ALCOHOL PRODUCTS” filed on Feb. 28, 2006.

### BACKGROUND OF THE INVENTION

1. Field of the Invention

The present invention relates to dietary nutritional supplements for humans, and more particularly to dietary nutritional supplements for humans who consume moderate to large amounts of alcohol. The definition of moderate alcohol consumption is somewhat vague and will vary from person to person, but as a general rule moderate alcohol consumption will refer to two or more alcoholic drinks consumed in the previous twenty-four hours. The dietary nutritional supplements of the present invention are also suitable for people who are habitual drinkers (five or more drinks weekly) and people suffering from addiction to alcohol.

2. Background Information

Alcohol consumption has well known detrimental effects on nutrition. The damage is done by the toxic effects of alcohol and by the nutrient deficiencies caused by alcohol in the body (alcohol is often understood to “strip” the body of certain nutrients). Heavy drinkers and chronic drinkers tend to have limited, inferior food choices, further causing nutritional deficiencies. They have used up their nutrient stores and are often drawing on their own tissues for fuel. There is rapid water loss (diuresis) within the first several hours of alcohol ingestion due to decreased secretion of an anti-diuretic hormone which is a pituitary peptide. Alcohol consumption can also lead to electrolyte depletion. Replacement of magnesium deficits is a recognized part of treatment of post-intoxication states. Hypocalcaemia may also result from magnesium depletion by reducing parathyroid hormone-induced mobilization of calcium from bone. Reduced serum phosphate may lead to muscle weakness and degeneration. Folic acid deficiency occurs in many binge-drinking alcoholics due to inadequate dietary intake, intestinal mal-absorption, and impaired folic acid storage due to the presence of alcohol in the system. Alcohol ingestion also interferes with vitamin B₁₂ absorption. Thiamine deficiency may occur in long-term alcohol users as a consequence of both inadequate ingestion and mal-absorption of the vitamin. With severe deficiency, major brain disturbance or alcoholic psychosis emerges (Wernicke-Korsakoff syndrome). Thiamine replacement corrects the grosser dysfunctions of the brain and it has been proposed that alcoholic beverages be fortified with thiamine as a means of preventing this syndrome. Pellagra, or niacin deficiency, is common in chronic alcoholics. Alcohol may increase the urinary loss of zinc and the gastrointestinal absorption of iron. Zinc deficiency aggravates vitamin A deficiency, since zinc is needed in the transformation of vitamin A into its active form.

Liver damage is the best known result of long-term alcohol abuse. The liver will swell with acute intoxication, sometimes painfully, and will show fatty infiltration and enlargement if alcoholic beverage ingestion continues regularly. With excessive alcohol consumption over many years, the ravaged liver becomes scarred, shrunken, and relatively non-functional. This end-stage cirrhosis is associated with the yellow, demented alcoholic, belly swollen with water (ascites).

Pancreatitis is often a consequence of alcoholism. Alcohol stimulates pancreatic secretion. Malnutrition with deficiencies of proteins and vitamins contributes to chronic pancreatic dysfunction. Impairment of pancreatic enzyme production spoils digestion and contributes to poor absorption of nutrients by the body. Decreased insulin production may cause or aggravate diabetes.

Alcoholic beverages contribute to malnutrition by replacing foods needed for essential nutrients and by interfering with absorption, storage or metabolism of the essential nutrients. Ethanol may suppress appetite and limit consumption of food. In some individuals, however, alcohol can trigger excessive eating instead. Food choices follow an addictive pattern, with nutrient deficiencies based on poor food choices. Bowel distension and diarrhea are common effects and are correlated with increased brain disturbances. The increased absorption of undigested proteins sets the stage for food “allergic” diseases.

There are many studies evidencing the nutritional depletion of the body due to alcohol, as briefly reviewed above. The detrimental effects of alcohol consumption can be minimized by addressing the nutritional depletion of the person. It is an object of the present invention to provide dietary nutritional supplements that are designed specifically to address the needs of moderate to heavy consumers of alcoholic beverages.

### SUMMARY OF THE INVENTION

The above stated object may be achieved with dietary nutritional supplements according to the present invention. An example of a nutritional supplement according to the present invention contains effective amounts of essential components vitamin B₂, vitamin B₆, vitamin B₁₂ (Cobalamin, including cyanocobalamin), vitamin B₃ (Niacin), vitamin B₁ (Thiamin), calcium, magnesium, vitamin A, vitamin C (ascorbic acid), folic acid, L-cysteine, L-methionine, Milk Thistle, selenium, dandelion, and molybdenum.

The supplements of the present invention may be in a liquid carrier, such as water or a fruit juice (e.g. apple juice or beet juice), or dairy based beverage (e.g. milk or yogurt). The supplements of the present invention may be formed in a baked good or confection such as a biscuit, cookie, chocolate bar (also known as energy bars). The supplements of the present invention may alternatively be in pill or tablet form, with one or more pills or tablets constituting a daily dosage. The supplements may also be in particulate (e. g., powder) form which may be pre-measured and packaged or packaged in bulk to be measured by the consumer and added to a carrier liquid, such as water. Other forms of the supplements are also possible.

These and other advantages of the present invention will be clarified in the description of the preferred embodiments.

### DESCRIPTION OF THE PREFERRED EMBODIMENTS

In certain embodiments of the present invention, the nutritional supplement contains effective amounts of essential components vitamin B₂, vitamin B₆, vitamin B₁₂ (Cobalamin), vitamin B₃ (Niacin), vitamin B₁ (Thiamin), calcium, magnesium, vitamin A, vitamin C (ascorbic acid), folic acid, L-cysteine, L-methionine, Milk Thistle, selenium, dandelion, and molybdenum.

Vitamin B complex is actually a combination of eight to eleven different vitamins, including: thiamin (B₁), riboflavin (B₂), niacin (B₃), folic acid, biotin, pantothenic acid or panthenol (B₅), pyridoxine, including pyridoxine HCl (B₆), choline, inositol, PABA, and cobalamin or cyanocobalamin (B₁₂). Collectively, the B complex vitamins are antioxidants and body regulators that work better together than alone. The B complex vitamins may be added to the nutritional supplements of the present invention as a mixture of the complex, and/or individually in separate amounts. As known to those of ordinary skill in the art, the individual B vitamins and B complex are separately commercially available. In certain embodiments of the present invention, in a single daily dosage of the supplement according to the present invention, vitamin B complex is used in an effective amount of ½-1½ grams, most often 1 gram.

Folic acid is a B complex water-soluble vitamin. It functions as a coenzyme in the breakdown and utilization of protein, together with vitamins B₁₂ and C. Folic acid functions as a carbon carrier in the formation of heme, the iron-containing protein found in hemoglobin, necessary for the formation of red blood cells. In addition, folic acid is needed for the formation of nucleic acid, which is necessary for the growth and reproduction of body cells. Folic acid is known to decrease the occurrence of some birth defects such as open neural tube defects. Folic acid is used in certain embodiments of the invention in an effective amount of 250-750 mg, often 500 mg. Alternatively, the folic acid may be supplied in a lower dose amount of 0.128-0.384 mg, often 0.256 mg, particularly when the supplement is prepared in tablet form.

Vitamin B₁₂, Also known as cobalamin or cyanocobalamin, is a water-soluble vitamin necessary for normal metabolism of nerve tissues and is active in carbohydrate, fat, and protein metabolism. B₁₂ improves the functions of iron in the metabolic cycle and assists folic acid in the synthesis of choline. It also plays an important role in the production of DNA and RNA, the genetic material of living cells. Vitamin B₁₂ helps in the formation and regeneration of red blood cells, thus helping prevent anemia; it is necessary for carbohydrate, fat, and protein metabolism; maintains a healthy nervous system; promotes growth in children; increases energy; and is needed for calcium absorption. Low vitamin B₁₂ levels damage nerve cells, aggravate nervous system disorders, and cause anemia. The prevalence of vitamin B₁₂ deficiency increases with age, especially over 65, and is frequently associated with Alzheimer's disease. Vitamin B₁₂ deficiency is also reported to be a risk factor for heart disease, stroke and accelerated aging. In certain embodiments of the present invention, in a single daily dosage of the supplement according to the present invention, vitamin B₁₂ is used in an effective amount of 12-38 mg, often 25 mg. Alternatively, the vitamin B₁₂ may be supplied in a lower dose amount of 4.8-14.1 μg, often 9.6 μg, particularly when the supplement is prepared in tablet form.

Vitamin B₃, niacin, improves circulation and reduces the cholesterol level in the blood; maintains the nervous system; helps metabolize protein, sugar and fat; reduces high blood pressure; increases energy through proper utilization of food; prevents pellagra; and helps maintain a healthy skin, tongue and digestive system. In certain embodiments of the present invention, in a single daily dosage of the supplement according to the present invention, niacin is used in an effective amount of 100-300 mg, often 200 mg. Alternatively, the niacin may be supplied in a lower dose amount of 11.5-34.5 mg, often 23 mg, particularly when the supplement is prepared in tablet form.

Vitamin B₁, thiamine or thiamin, may enhance circulation, helps with blood formation and the metabolism of carbohydrates. It is also required for the health of the nervous system and is used in the biosynthesis of a number of cell constituents, including the neurotransmitter acetylcholine and gamma-aminobutyric acid (GABA). It is used in the manufacture of hydrochloric acid, and therefore plays a part in digestion. It may also be helpful for the brain and may help with depression and assist with memory and learning. A deficiency may be indicated with extreme fatigue, irritability, constipation, edema and an enlarged liver. Forgetfulness, gastrointestinal disturbances, heart changes, irritability, labored breathing and loss of appetite may also be experienced. With too little thiamin a person may also experience nervousness, numbness of the hands and feet, pain and sensitivity, poor coordination, tingling sensations, weak and sore muscles, general weakness and severe weight loss. In certain embodiments of the present invention, in a single daily dosage of the supplement according to the present invention, thiamin is used in an effective amount of 100-300 mg, often 200 mg. Alternatively, the thiamin may be supplied in a lower dose amount of 1.05-3.15 mg, often 2.1 mg, particularly when the supplement is prepared in tablet form.

The majority of calcium in the human body is contained in the bones. One percent of the boy's calcium occurs outside of the bones, and is useful for the proper functioning of nerves, enzymes, muscles, and blood clotting. The parathyroid gland is the main regulator of calcium in the body. Low levels of calcium are associated with malnutrition. In certain embodiments of the present invention, in a single daily dosage of the supplement according to the present invention, calcium is used in an effective amount of 1000-3000 mg, often 2000 mg. Alternatively, the calcium may be supplied in a lower dose amount of 6-18 mg, often 12 mg, particularly when the supplement is prepared in tablet form. The calcium is typically provided in the form of tricalcium phosphate, although any form of edible calcium compounds, such as calcium carbonate, may be used.

Magnesium is an essential element which influences many enzymes needed to produce cellular energy and nerve and muscle message transmission. It affects nervous, muscular and cardiovascular systems. Magnesium is found mainly in bone, also in muscle and other tissues; deficiency can lead to neuromuscular and central nervous system irritability, muscle twitches and weakness. In certain embodiments of the present invention, in a single daily dosage of the supplement according to the present invention, magnesium is used in an effective amount of 250-750 mg, often 500 mg. Alternatively, the magnesium may be supplied in a lower dose amount of 26-78 mg, often 52 mg, particularly when the supplement is prepared in tablet form. The magnesium is typically supplied as magnesium oxide.

Vitamin A is a fat-soluble vitamin with antioxidant properties that is essential for proper immune system functioning including lymphocyte development and maturation. Vitamin A promotes growth and repair of body tissue, healthy eyes, good night vision and a strong immune system. In certain embodiments of the present invention, in a single daily dosage of the supplement according to the present invention, vitamin A is used in an effective amount of 500-3000 I.U., often 500-1500 IU, more often 1000 or 2000 I.U. The vitamin A is typically supplied as beta-carotene.

Vitamin C, ascorbic acid or ascorbate, is an antioxidant vitamin that protects cells from oxidative damage. Vitamin C is necessary for the production of collagen (e.g., for wound healing), hormones and neurotransmitters; it may have a role in fighting infection. Deficiency results in poor healing, easy bruising and anemia. Vitamin C is a water-soluble vitamin found in plants, especially in fruits and in leafy vegetables, or is made synthetically. It helps wounds heal, strengthens blood vessels, builds connective tissue, healthy gums, and skin and promotes strong teeth and bones, and may boost immunity. In certain embodiments of the present invention, in a single daily dosage of the supplement according to the present invention, vitamin C is used in an effective amount of 750-2300 mg, often 1500 mg. Alternatively, the vitamin C may be supplied in a lower dose amount of 25-75 mg, often 50 mg, particularly when the supplement is prepared in tablet form.

L-Cysteine is a conditionally essential amino acid and antioxidant. L-Cysteine is one of only three sulfur-containing amino acids, the others being taurine (which can be produced from L-cysteine) and L-methionine from which L-cysteine can be produced in the body by a multi-step process. L-cysteine can act as an antioxidant, may prevent liver diseases, and can help to thicken the individual diameters of existing hair if taken regularly. In certain embodiments of the present invention, in a single daily dosage of the supplement according to the present invention, L-Cysteine is used in an effective amount of 250-750 mg, often 500 mg. Alternatively, the L-Cysteine may be supplied in a lower dose amount of 12.5-37.5 mg, often 25 mg, particularly when the supplement is prepared in tablet form.

L-Methionine is an essential sulfur amino acid that aids in the body's detoxification processes. Sunflower seeds are a natural source of L-Methionine. L-Methionine has been used to treat depression, alcoholism, liver disease, and to reduce allergies and asthma. It has been used to reduce the toxic effects of radiation. This amino acid improves healing from surgery and other wounds. Some studies suggest that L-Methionine may reduce withdrawal symptoms and depression from heroin, barbiturates, or amphetamines. It can also be used as an adjunct to L-dopa treatment for Parkinson's disease. In certain embodiments of the present invention, in a single daily dosage of the supplement according to the present invention, L-Methionine is used in an effective amount of 250-750 mg, often 500 mg. Alternatively, the L-Methionine may be supplied in a lower dose amount of 12.5-37.5 mg, often 25 mg, particularly when the supplement is prepared in tablet form.

Milk Thistle, Silybum marianum, is an herb that has been used medicinally for functional disorders of the liver and gallbladder. It has been considered especially helpful in cases of jaundice, colitis, pleurisy, and diseases of the spleen. Milk thistle is indigenous to the South of Europe; however, today it can be found growing around the world. It is naturalized in most of Europe and North America. Milk Thistle's main active bio-constituent is Silymarin. Silymarin selectively acts as an anti-oxidant and protects the body from free radical damage specifically in the intestines and stomach. It increases the liver's content of GSH (glutathione) which is a substance used by the body in detoxifying many potentially damaging hormones, chemicals, and drugs (including acetaminophen) It has demonstrated a membrane stabilizing action, which inhibits or prevents lipid peroxidation. It seems to alter the structures of outer wall membranes of hepatocytes, preventing penetration of liver poisons and stimulates the action of nuclear polymerase. It may increase ribosomal protein synthesis and stimulate the formation of new hepatocytes. The commercial version of Milk Thistle is in powder form. Milk Thistle is typically supplied as Milk Thistle seed powder, and may be used in the formulation alone or in combination with additional silymarin. Milk Thistle is used in an effective amount of ½-1½ teaspoons, often 1 teaspoon in certain embodiments of the present invention. Alternatively, the Milk Thistle may be supplied in a lower dose amount of 25-75 mg, often 50 mg, particularly when the supplement is prepared in tablet form. Additional silymarin may be added in amounts of 45-125 mg, typically 87.5 mg.

Selenium is a trace mineral; its principal function is to inhibit fat oxidation, often or especially in conjunction with vitamin E. Selenium protects the immune system, maintains heart, liver, and pancreatic function, and keeps tissues elastic. It protects the liver during cirrhosis from alcoholism. Deficiency is associated with exhaustion, growth impairment, high cholesterol, infection, liver and pancreatic problems, heart disease and cancer. In certain embodiments of the present invention, in a single daily dosage of the supplement, selenium is used in an effective amount of 100-300 mg, often 200 mg. Alternatively, the selenium may be supplied in a lower dose amount of 17.5-52.5 μg, often 35 μg, particularly when the supplement is prepared in tablet form. The selenium is typically supplied as sodium selenides.

Dandelion, Taraxacum officinale, is an herb that has been historically known to cleanse the urinary system. Its name is a corruption of the French “dents de lion”, meaning teeth of the lion. Herbalists consider the plant one of the most nutrient-rich in the plant kingdom. The whole plant is edible, the flowers being used to make wine, the leaves boiled like spinach or added to salads, and the roots as a vegetable and as a coffee substitute. Modern studies have demonstrated that dandelion, taken in a salad or an herb tea, is cholagogic, increasing bile secretion. This is a property common to all edible bitter herbs. Dandelion is typically supplied as dandelion root powder. In certain embodiments of the present invention, in a single daily dosage of the supplement according to the present invention, dandelion is used in an effective amount of ½-1½ teaspoon, often 1 teaspoon. Alternatively, the dandelion may be supplied in a lower dose amount of 25-75 mg, often 50 mg, particularly when the supplement is prepared in tablet form.

Molybdenum is an essential trace mineral needed for the proper function of certain enzyme-dependent processes, including the metabolism of iron. In certain embodiments of the present invention, in a single daily dosage of the supplement according to the present invention, molybdenum is used in an effective amount of 100-300 micrograms (μg), often 175 micrograms. Alternatively, the molybdenum may be supplied in a lower dose amount of 25-75 μg, often 50 μg, particularly when the supplement is prepared in tablet form. The molybdenum is typically provided in the form of sodium molybdate.

A particular example of a nutritional supplement in accordance with the present invention has the following composition in a single daily dose: 1.2-3.6 mg vitamin B₂, 1.6-4.8 mg vitamin B₆, 4.8-14.1 μg vitamin B₁₂ (Cobalamin), 11.5-34.5 mg vitamin B₃ (Niacin), 1.05-3.15 mg vitamin B₁ (Thiamin), 6-18 mg calcium, 26-78 mg magnesium, 1000-3000 IU vitamin A, 25-75 mg vitamin C (ascorbic acid), 0.128-0.384 mg folic acid, 12.5-37.5 mg L-cysteine, 12.5-37.5 mg L-methionine, 25-75 mg Milk Thistle seed powder, 17.5-52.5 μg selenium, 25-75 mg dandelion root powder, and 25-75 μg Molybdenum.

The nutritional supplement of the present invention may additionally contain Bifidus (bifidobacterium bifidum). Bifidus, Bifidobacterium bifidum, creates a favorable environment for the growth of “good bacteria” in the large intestine. Integral functions of the large intestine include absorption of water from food that is consumed and the passage from the body of remaining waste products. The all-important presence of good intestinal flora not only promotes efficient digestion, it can help inhibit gas and bloating. When present in the supplement according to the present invention, a single daily dosage of the Bifidus is in an effective amount of ½-1½ teaspoons, often 1 teaspoon.

Vitamin D may also be present in the nutritional supplements of the present invention. Vitamin D is a fat-soluble vitamin that enhances the absorption of calcium and phosphorus from the intestine and promotes their deposition onto the bone. Vitamin D is needed for the normal growth of bones and teeth. In a single daily dosage of the supplement according to the present invention vitamin D may be used in an effective amount of 150-450 I.U., often 300 I.U.

The nutritional supplements of the present invention may additionally contain L-Tyrosine. L-Tyrosine is a direct precursor to Thyroxine, a primary thyroid hormone, as well as Adrenaline and Nor-adrenaline. Thyroxine has been found to increase metabolic rate and control growth rate. L-Tyrosine is a necessary amino acid in the production of neurotransmitters including epinephrine, norepinephrine, and dopamine. L-Tyrosine also appears to have a mild stimulatory effect on the central nervous system. Patients with a Thyroxine deficiency have symptoms including excess weight gain, cold hands and feet, and decreased basal metabolism. L-Tyrosine has been found to assist in optimizing thyroid hormone levels, increased mood, concentration, and productivity. L-Tyrosine is used to treat conditions including depression or mood disorder, poor coping ability, fatigue, low sex drive, low metabolism, and drug abuse (when combined with Tryptophan). It can also improve endurance under stress and is effective as an appetite suppressant. When taken properly, L-Tyrosine can assist a sluggish thyroid and aid the dieter in losing excess, unwanted pounds. In a single daily dosage of the supplement according to the present invention, L-tyrosine may be used in an effective amount of 250-750 mg, often 500 mg.

The nutritional supplements of the present invention may additionally contain ginseng. Ginseng, Panax ginseng, is the most famous Chinese herb. It is the most widely recognized plant used in traditional medicine. Various forms of ginseng have been used in medicine for more than 7000 years. Several species grow around the world, and though some are preferred for specific benefits, all are considered to have similar properties as an effective general rejuvenator. The name panax is derived from the Greek word panacea meaning, “all healing” and the benefits of ginseng are recognized as such. Ginseng is commonly used as an adaptogen, meaning it normalizes physical functioning depending on what the individual needs (for example, it will lower high blood pressure, but raise low blood pressure). It is also used to reduce the effects of stress, improve performance, boost energy levels, enhance memory, and stimulate the immune system. Ginseng contains vitamins A, B₆ and the mineral zinc, which aids in the production of thymic hormones, necessary for the functioning of the immune defense system. The main active ingredients of ginseng are the more than 25 saponin triterpenoid glycosides called “ginsenosides”. These steroid-like ingredients provide the adaptogenic properties that enable ginseng to balance and counter the effects of stress. The glycosides appear to act on the adrenal glands, helping to prevent adrenal hypertrophy and excess corticosteroid production in response to physical, chemical or biological stress. Ginseng is used to restore memory, and enhance concentration and cognitive abilities, which may be impaired by improper blood supply to the brain. Ginseng is also used for diabetes, radiation and chemotherapy protection, colds, chest problems, to aid in sleep, and to stimulate the appetite. In a single daily dosage of the supplement according to the present invention Ginseng may be used in an effective amount of 2-8 ml, often 5 ml.

The nutritional supplements of the present invention may additionally contain glutathione. Glutathione is a small protein composed of three amino acids, namely cysteine, glutamic acid and glycine. Glutathione is involved in detoxification—it binds to toxins, such as heavy metals, solvents, and pesticides, and transforms them into a form that can be excreted in urine or bile. Glutathione is also an important antioxidant. In a single daily dosage of the supplement according to the present invention glutathione may be used in an effective amount of 250-750 mg, often 500 mg.

The nutritional supplements of the present invention may additionally contain tryptophan. Tryptophan is an essential amino acid. A natural relaxant, Tryptophan helps alleviate insomnia by inducing normal sleep; reduces anxiety and depression; helps in the treatment of migraine headaches; helps the immune system; helps reduce the risk of artery and heart spasms; and works with Lysine in reducing cholesterol levels. In a single daily dosage of the supplement according to the present invention tryptophan may be used in an effective amount of 500-1500 mg, often 1000 mg.

The nutritional supplements of the present invention may additionally contain zinc. Zinc is essential to the synthesis of DNA and RNA, of proteins, insulin and sperm. The body also needs zinc to metabolize carbohydrates, fats, protein and alcohol; to dispose of carbon dioxide; to make good use of vitamin A. More than seventy different enzymes require zinc to work effectively within the body. Zinc also bolsters the immune system and facilitates the healing of wounds. It is integral to the growth and maintenance of body tissues; it plays a major role in the development of fetuses and the growth of children. In a single daily dosage of the supplement according to the present invention zinc may be used in an effective amount of 12-38 mg, often 25 mg.

A particular example of a nutritional supplement in accordance with the present invention has the following composition in a single daily dose: 0.5-1.5 teaspoons bifidobacterium bifidum, 0.5-1.5 g vitamin B complex, 12-38 mg vitamin B₁₂ (Cobalamin), 100-300 mg vitamin B₃ (Niacin), 100-300 mg vitamin B₁ (Thiamin), 1000-3000 mg calcium, 250-750 mg magnesium, 500-1500 IU vitamin A, 750-2300 mg vitamin C (ascorbic acid), 150-450 IU vitamin D, 250-750 mg folic acid, 250-750 mg L-cysteine, 250-750 mg L-methionine, 0.5-1.5 teaspoons Milk Thistle seed powder, 250-750 mg L-tyrosine, 2-8 ml ginseng, 100-300 mg selenium, 500-1500 mg tryptophan, 0.5-1.5 teaspoons dandelion root powder, 250-750 mg glutathione, 12-38 mg zinc, and 100-300 μg molybdenum.

A specific embodiment of a nutritional supplement according to the present invention has the following composition in a single daily dose: 1 teaspoon bifidobacterium bifidum, 1 gram vitamin B complex, 25 mg vitamin B₁₂ (Cobalamin), 200 mg vitamin B₃ (Niacin), 200 mg vitamin B₁ (Thiamin), 2000 mg calcium, 500 mg magnesium, 1000 I.U. vitamin A, 1500 mg vitamin C (ascorbic acid), 300 I.U. vitamin D, 500 mg folic acid, 500 mg L-cysteine, 500 mg L-methionine, 500 mg L-tyrosine, 5 ml ginseng, 200 mg selenium, 1000 mg tryptophan, 1 teaspoon dandelion root powder, 500 mg glutathione, 175 micrograms molybdenum and 25 mg zinc.

In addition to vitamin C and other antioxidants discussed above, the nutritional supplements of the present invention may contain additional antioxidants. Examples of suitable antioxidants include vitamin E (tocopherol), lutein, and/or grape seed extract.

Vitamin E occurs naturally in plants, in particular in wheat germ, in α-, β-, γ-, and δ- isomers. The α- isomer is the most potent. Vitamin E deficiencies may cause muscular and central nervous system depletion. In a single daily dosage of the supplement according to the present invention, vitamin E may be used in an effective amount of 19-57 IU, often 38 IU.

Lutein is one of over 600 known naturally occurring carotenoids. It is found in green leafy vegetables such as spinach and kale. It is believed that a direct relationship exists between lutein intake and pigmentation in the eye, in particular in the macula. Several studies also show that an increase in macula pigmentation decreases the risk for eye diseases such as Age-related Macular Degeneration (AMD). In a single daily dosage of the supplement according to the present invention, lutein may be used in an effective amount of 0.1-0.3 mg, often 0.2 mg.

Grape seed extract contains proanthocyanidins. Proanthocyanidins-also called “OPCs” for oligomeric proanthocyanidins and “PCOs” for procyanicolic oligomers, are a class of nutrients belonging to the bioflavonoid family. The main functions of proanthocyanidins are believed to be antioxidant activity, stabilization of collagen, and maintenance of elastin—two critical proteins in connective tissue, blood vessels and muscle. In a single daily dosage of the supplement according to the present invention, grape seed extract may be used in an effective amount of 12.5-37.5 mg, often 25 mg.

The nutritional supplements of the present invention may additionally contain vanadium. Vanadium is an essential component of some enzymes. Vanadium has also been shown to alleviate diabetes mellitis symptoms in humans. Vanadium is typically supplied to the supplement formulation as sodium metavanadate. In a single daily dosage of the supplement according to the present invention, vanadium may be used in an effective amount of 3-9 μg, often 6.4 μg.

The nutritional supplements of the present invention may additionally contain turmeric, typically supplied as ground turmeric root. Recent studies suggest that curcumin, the active ingredient in turmeric, might inhibit the accumulation of destructive beta amyloids in the brains of Alzheimer's disease patients and also break up existing plaques. It is also said that turmeric can strengthen the blood-brain barrier against attacks that result from auto-immune diseases such as multiple sclerosis. Curcumin is also thought to be a powerful antinociceptive (pain-relieving) agent, with studies showing the effectiveness of turmeric in the reduction of joint inflammation. It is additionally thought to work as a natural inhibitor of the cox-2 enzyme, and has been shown to be effective in animal models for neuropathic pain secondary to diabetes, among others. In a single daily dosage of the supplement according to the present invention, turmeric may be used in an effective amount of 15-45 mg, often 30 mg.

A particular example of a nutritional supplement in accordance with the present invention has the following composition in a single daily dose: 1.2-3.6 mg vitamin B₂, 1.6-4.8 mg vitamin B₆, 4.8-14.1 μg vitamin B₁₂ (Cobalamin), 11.5-34.5 mg vitamin B₃ (Niacin), 1.05-3.15 mg vitamin B₁ (Thiamin), 6-18 mg Calcium, 26-78 mg magnesium, 1000-3000 IU vitamin A, 25-75 mg vitamin C (ascorbic acid), 0.128-0.384 mg folic acid, 12.5-37.5 mg L-cysteine, 12.5-37.5 mg L-methionine, 25-75 mg Milk Thistle seed powder, 17.5-52.5 μg selenium, 25-75 mg dandelion root powder, 25-75 μg Molybdenum, 19-57 IU vitamin E, 0.05-0.150 mg Biotin, 5-15 mg pantothenic acid, 3-9 μg vanadium, 12.5-37.5 mg grape seed extract, 0.1-0.3 mg lutein, 45-125 mg silymarin, and 15-45 mg ground turmeric root.

A specific embodiment of a nutritional supplement according to the present invention has the following composition in a single daily dose: 2.4 mg vitamin B₂, 3.2 mg vitamin B₆, 9.6 μg vitamin B₁₂ (Cobalamin), 23 mg vitamin B₃ (Niacin), 2.1 mg vitamin B₁ (Thiamin), 12 mg Calcium, 52 mg magnesium, 2000 IU vitamin A, 50 mg vitamin C (ascorbic acid), 0.256 mg folic acid, 25 mg L-cysteine, 25 mg L-methionine, 50 mg Milk Thistle seed powder, 35 μg selenium, 50 mg dandelion root powder, 50 μg Molybdenum, 38 IU vitamin E, 0.105 mg Biotin, 11.1 mg pantothenic acid, 6.4 μg vanadium, 25 mg grape seed extract, 0.2 mg lutein, 87.5 mg silymarin, and 27.5 mg ground turmeric root.

Optional ingredients in the nutritional supplements of the present invention include marshmallow root. Marshmallow root, Althaea officinalis, is also known by the names Althea, Mallards, Sweet Weed, Hock Herb, Wymote, and Schloss Tea. The genus name Althea is from the Greek word “althe” and means “to heal”. Marshmallow Root powder has been used as a binding agent to hold other herbs together in making pills, and has been commonly substituted for Slippery Elm in herbal remedies. Marshmallow is a native of most countries of Europe, from Denmark southward, and is found in the western U.S.

Primary chemical constituents of Marshmallow include mucilage, polysaccharides, flavonoids (quercetin, kaaempferoo), asparagine, tannins, lecithin, and pectin. The great demulcent and emollient properties of Marshmallow make it useful in inflammation and irritation of the alimentary canal, and of the urinary and respiratory organs. Marshmallow has also been used as an expectorant to treat a variety of upper respiratory problems. Marshmallow contains large amounts of vitamin A, calcium, zinc and significant amounts of iron, sodium, iodine, and B-complex. Like slippery elm, Marshmallow reduces inflammation and has a calming effect on the body. The active constituents in Marshmallow are large carbohydrate (sugar) molecules, which make up the mucilage. This smooth, slippery substance can soothe and protect irritated mucous membranes. Although Marshmallow has primarily been used for the respiratory and digestive tracts, its high mucilage content may also provide some minor relief for urinary tract and skin infections. Marshmallow's mucilage content helps soothe inflamed tissues, often caused by bronchitis and asthma. Marshmallow also relieves dryness and irritation in the chest and throat, usually brought on by colds and persistent coughs. Marshmallow has been known to relieve indigestion, kidney problems, urinary tract infections, and even external skin wounds such as boils and abscesses. In a single daily dosage of the supplement according to an alternative embodiment of the present invention Marshmallow is used, and added to the remaining constituents, in an effective amount of 2-8 ml, often 5 ml. The commercially available form of marshmallow root is in powder form.

What is claimed is:

1. A nutritional supplement for persons with moderate to heavy alcohol consumption comprising effective amounts of vitamin B₂, vitamin B₆, vitamin B₁₂ (Cobalamin), vitamin B₃ (Niacin), vitamin B₁ (Thiamin), calcium, magnesium, vitamin A, vitamin C (ascorbic acid), folic acid, L-cysteine, L-methionine, Milk Thistle, selenium, dandelion, and molybdenum.

2. The nutritional supplement of claim 1 wherein the effective amounts of each component comprise in a single daily dose: 1.2-3.6 mg vitamin B₂, 1.6-4.8 mg vitamin B₆, 4.8-14.1 μg vitamin B₁₂ (Cobalamin), 11.5-34.5 mg vitamin B₃ (Niacin), 1.05-3.15 mg vitamin B₁ (Thiamin), 6-18 mg Calcium, 26-78 mg magnesium, 1000-3000 IU vitamin A, 25-75 mg vitamin C (ascorbic acid), 0.128-0.384 mg folic acid, 12.5-37.5 mg L-cysteine, 12.5-37.5 mg L-methionine, 25-75 mg Milk Thistle seed powder, 17.5-52.5 μg selenium, 25-75 mg dandelion root powder, and 25-75 μg Molybdenum.

3. The nutritional supplement of claim 1 wherein the vitamin B₆ is supplied as pyridoxine HCl.

4. The nutritional supplement of claim 1 wherein the vitamin B₁₂ is supplied as cyanocobalamin.

5. The nutritional supplement of claim 1 wherein the calcium is supplied as tricalcium phosphate.

6. The nutritional supplement of claim 1 wherein the magnesium is supplied as magnesium oxide.

7. The nutritional supplement of claim 1 wherein said supplement is in the form of a tablet.

8. A nutritional supplement for persons with moderate to heavy alcohol consumption comprising effective amounts of bifidobacterium bifidum, vitamin B complex, vitamin B₁₂, (Cobalamin), vitamin B₃ (Niacin), vitamin B₁ (Thiamin), Calcium, magnesium, vitamin A, vitamin C (ascorbic acid), vitamin D, folic acid, L-cysteine, L-methionine, Milk Thistle, L-tyrosine, ginseng, selenium, tryptophan, dandelion, glutathione, molybdenum and zinc.

9. The nutritional supplement of claim 8 wherein the effective amounts of each component comprise in a single daily dose: 0.5-1.5 teaspoons bifidobacterium bifidum, 0.5-1.5 g vitamin B complex, 12-38 mg vitamin B₁₂ (Cobalamin), 100-300 mg vitamin B₃ (Niacin), 100-300 mg vitamin B₁ (Thiamin), 1000-3000 mg Calcium, 250-750 mg magnesium, 500-1500 IU vitamin A, 750-2300 mg vitamin C (ascorbic acid), 150-450 IU vitamin D, 250-750 mg folic acid, 250-750 mg L-cysteine, 250-750 mg L-methionine, 0.5-1.5 teaspoons Milk Thistle seed powder, 250-750 mg L-tyrosine, 2-8 ml ginseng, 100-300 mg selenium, 500-1500 mg tryptophan, 0.5-1.5 teaspoons dandelion root powder, 250-750 mg glutathione, 12-38 mg zinc, and 100-300 μg Molybdenum.

10. The nutritional supplement of claim 8 wherein the vitamin B₁₂ is supplied as cyanocobalamin.

11. The nutritional supplement of claim 8 wherein the calcium is supplied as tricalcium phosphate.

12. The nutritional supplement of claim 8 wherein the magnesium is supplied as magnesium oxide.

13. A nutritional supplement for persons with moderate to heavy alcohol consumption comprising effective amounts of vitamin B₂, vitamin B₆, vitamin B₁₂ (Cobalamin), vitamin B₃ (Niacin), vitamin B₁ (Thiamin), calcium, magnesium, vitamin A, vitamin C (ascorbic acid), folic acid, L-cysteine, L-methionine, Milk Thistle seed, selenium, dandelion, molybdenum, vitamin E, Biotin, pantothenic acid, vanadium, grape seed extract, lutein, silymarin, and turmeric.

14. The nutritional supplement of claim 13 wherein the effective amounts of each component comprise in a single daily dose: 1.2-3.6 mg vitamin B₂, 1.6-4.8 mg vitamin B₆, 4.8-14.1 μg vitamin B₁₂ (Cobalamin), 11.5-34.5 mg vitamin B₃ (Niacin), 1.05-3.15 mg vitamin B₁ (Thiamin), 6-18 mg calcium, 26-78 mg magnesium, 1000-3000 IU vitamin A, 25-75 mg vitamin C (ascorbic acid), 0.128-0.384 mg folic acid, 12.5-37.5 mg L-cysteine, 12.5-37.5 mg L-methionine, 25-75 mg Milk Thistle seed powder, 17.5-52.5 μg selenium, 25-75 mg dandelion root powder, 25-75 μg molybdenum, 19-57 IU vitamin E, 0.05-0.150 mg Biotin, 5-15 mg pantothenic acid, 3-9 μg vanadium, 12.5-37.5 mg grape seed extract, 0.1-0.3 mg lutein, 45-125 mg silymarin, and 15-45 mg ground turmeric root.

15. The nutritional supplement of claim 13 wherein the vitamin B₆ is supplied as pyridoxine HCl.

16. The nutritional supplement of claim 13 wherein the vitamin B₁₂ is supplied as cyanocobalamin.

17. The nutritional supplement of claim 13 wherein the calcium is supplied as tricalcium phosphate.

18. The nutritional supplement of claim 13 wherein the magnesium is supplied as magnesium oxide.

19. The nutritional supplement of claim 13 wherein said supplement is in the form of a tablet.

20. The nutritional supplement of claim 13 wherein the effective amounts of each component comprise in a single daily dose: 2.4 mg vitamin B₂, 3.2 mg vitamin B₆, 9.6 μg vitamin B₁₂ (Cobalamin), 23 mg vitamin B₃ (Niacin), 2.1 mg vitamin B₁ (Thiamin), 12 mg Calcium, 52 mg magnesium, 2000 IU vitamin A, 50 mg vitamin C (ascorbic acid), 0.256 mg folic acid, 25 mg L-cysteine, 25 mg L-methionine, 50 mg Milk Thistle seed powder, 35 μg selenium, 50 mg dandelion root powder, 50 μg Molybdenum, 38 IU vitamin E, 0.105 mg Biotin, 11.1 mg pantothenic acid, 6.4 μg vanadium, 25 mg grape seed extract, 0.2 mg lutein, 87.5 mg silymarin, and 27.5 mg ground turmeric root.
